(19) United States
(12) Patent Application Publication
(10) Pub. No.: US 2013/0189440 A1
(43) Pub. Date: Jul. 25, 2013

(54) Masking Tape Sealant and Applicator

(71) Applicant: Dan Brian Pool, Scottsdale, AZ (US)

(72) Inventor: Dan Brian Pool, Scottsdale, AZ (US)

(21) Appl. No.: 13/744,939

(22) Filed: Jan. 18, 2013

Related U.S. Application Data
(60) Provisional application No. 61/588,532, filed on Jan. 19, 2012.

(51) Int. Cl. B05C 1/00

(52) U.S. Cl. CPC B05C 1/00
USPC 427/429; 401/261; 401/264; 524/556

(57) ABSTRACT

A masking tape sealant and applicator includes a bottle with an applicator brush or tip which contains an acrylic material composed of water based acrylic primer designed to seal the edges of masking tape to prevent tape bleed and to create crisp, fine paint lines.

### RELATED APPLICATIONS

This application claims the benefit of the earlier filing dates of U.S. Provisional Application No. 61/588,532 filed Jan. 19, 2012. The disclosure U.S. Provisional Application 61/588,532 is hereby incorporated by reference in its entirety.

### FIELD OF THE INVENTION

The present invention relates to painting on a variety of surfaces such as drywall, walls, doors, and window frames. The present invention more particularly relates to the various methods painters use to create paint lines and borders. Often in the course of painting, painters want to leave behind a crisp border, and have various methods to do so which the present invention improves upon.

### BACKGROUND OF THE INVENTION

Painters will often use various masking tapes to define lines and borders on the surfaces they are painting. The masking tape is applied to the surface where the painter desires the border to go, and then the painter paints the area that needs to be painted up to and partially over the tap boundary. The paint is allowed to dry, and then the masking tape is removed. The masking tape, in theory, should leave behind a crisp, well-defined, straight line, but often times this is not the case because masking tape is generally made from adhesive backed crepe paper causing the paint to bleed underneath the tape.

Attempts to mitigate paint bleed include the use of masking tapes, premium masking tapes, and other homemade and store-bought remedies. However, these attempts are generally unsatisfactory for a number of reasons. For example, masking tape, as detailed above, does not effectively seal out all paint as gaps in the adhesive material of the crepe paper cause the paint to bleed underneath the tape. Additionally, premium masking tapes are slightly more effective at preventing paint bleed, but these products are only effective on smooth surfaces as textured surfaces allow the paint to still bleed through. Also, it is well-known in the profession that professional painters prevent paint bleed by taking caulk and running it down the edges of the masking tape with their fingers, but this technique is messy and it is likely that do it yourself painters may not have caulk at their disposal. Finally, there is an acrylic product in a tub that is used to seal the tape edges, but this product comes by itself in the tub and the customer needs to use a brush to brush the acrylic against the tape edges. Thus, there is a need for a way to prevent paint bleed that overcomes the disadvantages of the prior art.

### SUMMARY OF THE INVENTION

The present invention meets this need by using a bottle with an applicator brush tip to apply an acrylic material composed of water based acrylic primer along the tape and surface edge in order to create fine lines and borders when painting. More specifically, the solution is a waterborne solvent, 100% acrylic resin with a flat finish. In one aspect of the invention, the acrylic material is contained in a bottle with a sponge applicator tip which aids in applying the solution to the intended surface. In another aspect of the invention, the acrylic material is applied to said surface and helps to create a desired boundary between the surface and the tape by sealing the edge of the tape so that paint cannot bleed underneath the tape. When masking tape is applied to a surface, there are tiny gaps between the tape and the surface that allow paint to penetrate the desired boundary of the tape. When the sealant is applied via the brush and bottle being pressed against the edge of the tape line, it fills the gaps that are left behind between the surface and the tape. The acrylic solution is not necessarily dear in its liquid form, but it dries on clear. The paint is applied, and then allowed to dry. When the tape is removed, it leaves a sharp boundary between the surface that was just painted and the area where the tape had been placed.

### BRIEF DESCRIPTION OF THE DRAWINGS

These and other features, aspects, and advantages of the present invention will become better understood with reference to the following description, appended claims, and accompanying drawings, where:

FIG. 1 is a view of the bottle containing the acrylic solution and

FIG. 2 shows the invention in use sealing the edge of a piece of masking tape.

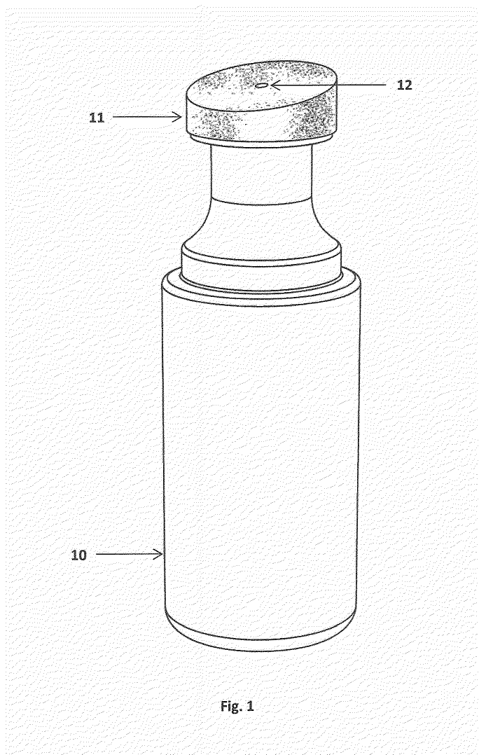

With reference to FIG. 1, a masking tape applicator includes a plastic bottle 10 to hold the acrylic material. A brush applicator tip 11 is attached to the top of the bottle composed of foam which aids in applying the acrylic to the desired surface. The foam material does not dry out from repeated contact with the acrylic so this allows the material and bottle to have multiple uses. The foam tip 11 is attached to the bottle with a hole 12 in the middle to allow the acrylic to be applied to the desired surface.

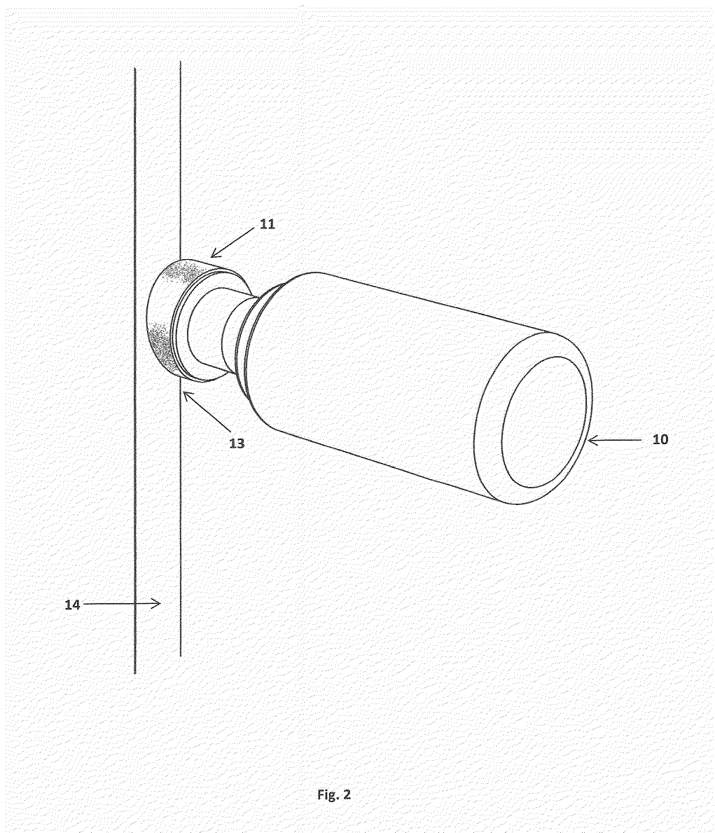

With reference to FIG. 2, a masking tape applicator 10 is shown in use. The foam tip 11 absorbs the material when pressure is applied to the bottle. The desired amount of material is applied by placing pressure against the foam tip to the surface where the paint boundary is to be created. The applicator 10 is shown applying material to the edge 13 of a piece of masking tape 14. The foam tip then allows the user to evenly spread the acrylic against the intended surface. In addition, the foam applicator tip is angled so that the user does not have to press the bottle perpendicular to the wall.

After the acrylic material dries, the tape is removed leaving a fine line behind.

From the above description of the invention, those skilled in the art will perceive improvements, changes and modifications. Such improvements, changes and modifications within the skill of the art are intended to be covered by the appended claims.

Having described the invention, the following is claimed:

1. A method of applying a transparent liquid sealant to a strip of masking tape using a bottle with an angled foam tip applicator;

2. The solution of claim 1 composed of water based acrylic primer to be applied to create fine paint lines on a surface such as a wall or border trim;

3. The foam tip applicator of claim 1, which when coupled with the acrylic solution allows the user to apply the desired amount of solution to the intended surface where the border is to be created;

4. The foam tip applicator of claim 1, which allows the user to apply a uniform pressure to the tape which helps seal the edge of the masking tape.
